(19) United States
(12) Patent Application Publication
(10) Pub. No.: US 2005/0129407 A1
(43) Pub. Date: Jun. 16, 2005

(54) Imaging lens for multi-channel free-space optical interconnects

(76) Inventor: Christopher L. Coleman, Santa Clara, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/733,012

(22) Filed: Dec. 10, 2003

(51) Int. Cl. H04B 10/00

(52) U.S. Cl. 398/130

(57) ABSTRACT

A free-space parallel optical interconnect includes a first module and a second module. The first module includes (1) a first die having an array of light sources each emitting light and (2) a first common lens for directing the light from each light source to the second module. The second module includes (1) a second die having an array of detectors and (2) a second common lens for directing the light from each light source to a corresponding detector.

### FIELD OF INVENTION

This invention relates to multi-channel free-space optic interconnects.

### DESCRIPTION OF RELATED ART

Free-space optical interconnects are intended for systems in which data must be transferred across short distances and there exists an unobstructed line of sight between the transmitter and the receiver. In these systems, an optical fiber is not used as a transport medium to carry the light from one end of the link to the other. Instead, the light is allowed to propagate freely in air as it travels from one device to the next. In links that require large amounts of data to be moved, parallel arrays of lasers and detectors are employed to push more data through the system at the same time. Conventionally, parallel arrays are composed of multiple copies of a single channel solution, with each channel using its own individual coupling optics. This kind of architecture demands that the lasers and detectors be built on a spacing that is large compared to their diameters and economically becomes a poor use of the semiconductor material.

FIG. 1 illustrates such a conventional free-space parallel optical interconnect 10, which uses two identical but independent lens systems. Both channels are constructed as independent links with individual optics assembled in an array. Optical interconnect 10 includes a transmitter 12 having a die 14 with multiple (e.g., two) lasers 16. Each laser has its own lens 18 to collimate light emitted by the laser into a beam toward a receiver 20. Receiver 20 includes a die 22 with multiple (e.g., two) detectors 24. Each detector has its own lens 26 to focus the light beam onto the detector. Lasers 16 and detectors 24 must be manufactured on a large pitch P1, which is dictated by the required aperture size of the lenses 18 and 26. In other words, the pitch of lasers 16 and detectors 24 is forced to have the same pitch as the aperture of the lenses 18 and 26. Two 10 micron (um) laser apertures are then separated by 250 um, resulting in a large area of expensive and wasted semiconductor real estate. Thus, what is needed is a free-space parallel optical interconnect that addresses the space inefficiencies of the conventional optical interconnect 10.

### SUMMARY

In one embodiment of the invention, a free-space parallel optical interconnect includes a first module and a second module. The first module includes (1) a first die having an array of light sources each emitting light and (2) a first common lens for directing the light from each light source to the second module. The second module includes (1) a second die having an array of detectors and (2) a second common lens for directing the light from each light source to a corresponding detector.

### BRIEF DESCRIPTION OF THE DRAWINGS

FIG. 1 illustrates a conventional free-space parallel optical interconnect.

FIGS. 2, 3, 4, 5, 6, and 7 illustrate a free-space parallel optical interconnect and its modules in various embodiments of the invention.

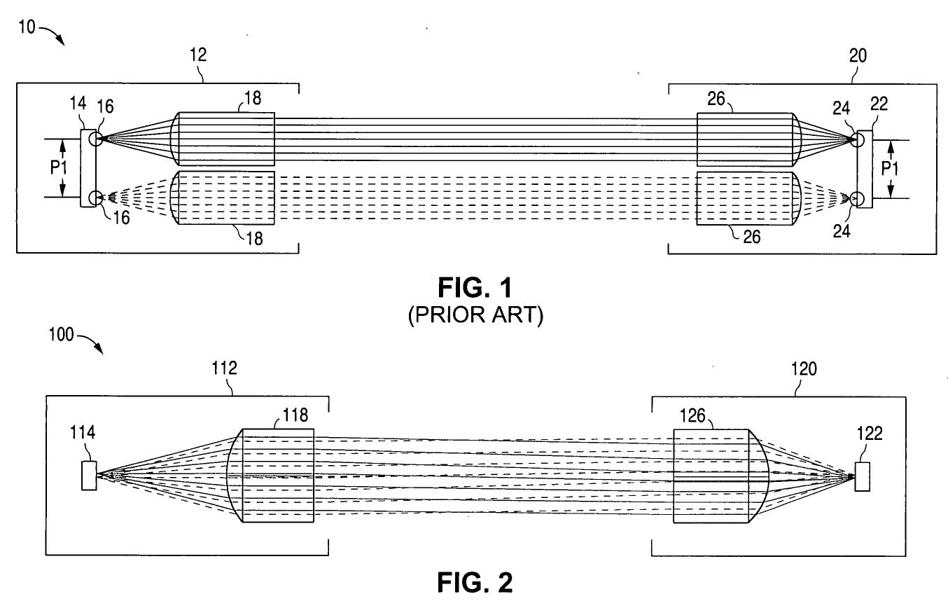

Note that the light rays shown in various figures are for illustrative purposes only and may not be accurate.

### DETAILED DESCRIPTION

In one embodiment of the invention, a free-space parallel optical interconnect uses a single lens to simultaneously couple all laser channels so that the laser channels can be spaced closer together. Instead of spacing the channels by 250 um, as is common for parallel arrays with individual optics, a single, common optic would drive the laser spacing to a separation of, for example, only 50 um. This is a greater than a five (5) time reduction in the semiconductor area for an equal number of lasers. The laser cost, which is typically the dominant cost of a module, is roughly linearly related to the area it occupies on a wafer. Using a single coupling optic for all channels could dramatically reduce the cost of both laser and photodetector components in a module.

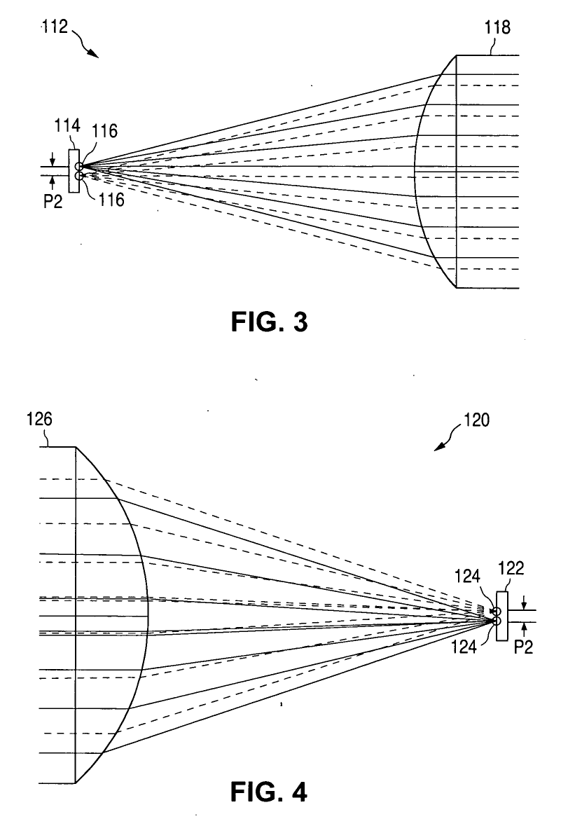

FIG. 2 illustrates a free-space parallel optical interconnect 100 in one embodiment of the invention. Optical interconnect 100 includes a module 112 (e.g., a transmitter) having a die 114 with an array of light sources 116 (e.g., two lasers 116 as shown in FIG. 3). Both laser channels in the array share a common coupling optic 118, which encourages the laser spacing to be as small as possible.

FIG. 3 illustrates the details of transmitter 112 in one embodiment. Optics 118 is a collimating lens that collimates light from lasers 116 into overlapping beams directed toward a module 120 (e.g., a receiver). Although the communication channels are shown as overlapping in the space between transmitter 112 and receiver 120, due to the nature of optical imaging, the data channels will eventually be separated and isolated at receiver 120 with negligible amounts of crosstalk. The pitch between lasers 116, measured from their centers, is selected to be compatible with the pitch of corresponding detectors in receiver 120. In one embodiment, two 10 um laser apertures are spaced apart by a pitch P2 of 50 um on die 114, which provides a real estate savings of over five (5) times compared to conventional die 14. Lasers 116 can be vertical cavity surface emitting lasers (VCSELs), edge-emitting lasers, or light emitting diodes (LEDs).

Referring back to FIG. 2, receiver 120 includes a die 122 with an array of detectors 124 (e.g., two detectors 124 as shown in FIG. 4). Both detector channels in the array share a common coupling optic 126, which again encourages the detector spacing to be as small as possible.

FIG. 4 illustrates the details of receiver 120 in one embodiment. Optics 126 is a converging lens that separates the overlapping light beams and focuses each on a corresponding photodetector with negligible amounts of crosstalk. Note that pitch P2 can vary depending on the size of detectors 124, which can range from 30 to 80 um. In one embodiment, two detectors 124 are spaced apart by a pitch P2 of 50 um on die 122, which provides a real estate savings of over five (5) times compared to conventional die 22. Detectors 124 can be positive-intrinsic-negative (PIN) photodiodes.

Thus, free-space parallel optical interconnect 100 uses a common lens system to provide the simultaneous coupling for both parallel channels. The advantage of this design is that the semiconductor devices can be produced at much higher density, leading to dramatically lower cost components and modules.

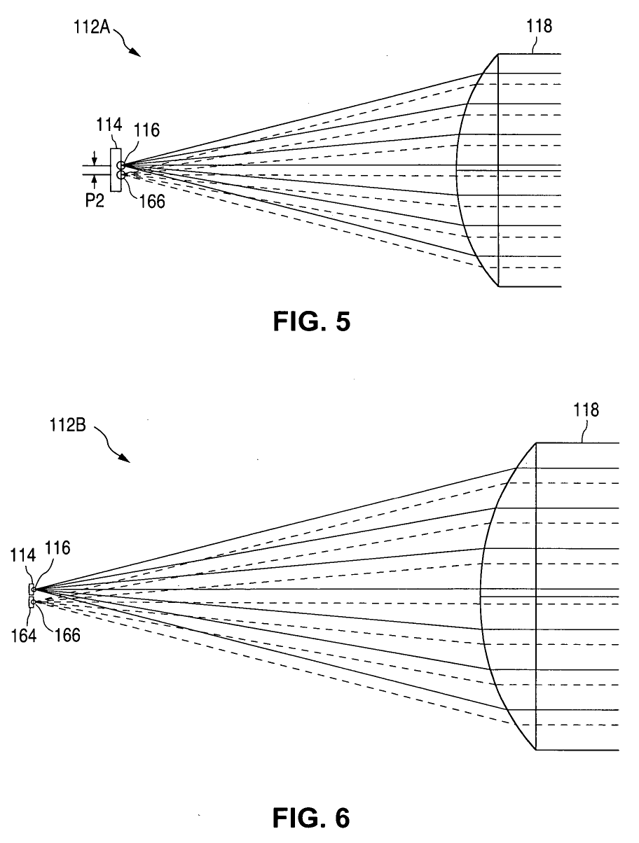

FIG. 5 illustrates the details of a transceiver 112A in one embodiment. Transceiver 112A is similar to transmitter 112 except that die 114 further includes an array of detectors 166. For clarity, only one laser 116 and one detector 166 are shown. Here, common lens 118 is used to direct light from lasers 116 to another module (e.g., another transceiver) and to direct light from the other module onto corresponding detectors 166.

FIG. 6 illustrates the details of a transceiver 112B in one embodiment. Transceiver 112B is similar to transmitter 112 but further includes a die 166. Die 166 includes an array of detectors 166. For clarity, only one laser 116 and one detector 166 are shown. Again, common lens 118 is used to direct light from lasers 116 to another module (e.g., another transceiver) and to direct light from the other module onto corresponding detectors 166.

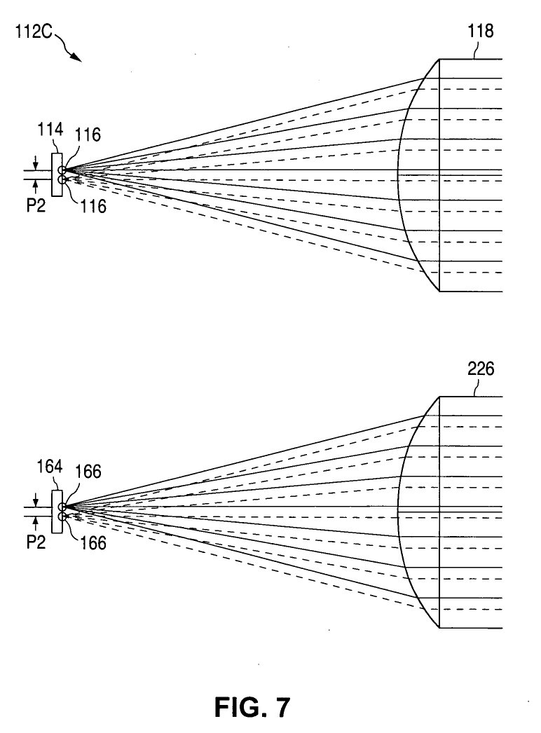

FIG. 7 illustrates the details of a transceiver 112C in one embodiment. Transceiver 112C is similar to transmitter 112B (FIG. 6) but uses a separate common lens 226 for directing light from the other module (e.g., another transceiver) onto corresponding detectors 166.

Various other adaptations and combinations of features of the embodiments disclosed are within the scope of the invention. Although only two channels are illustrated, optical interconnect 100 can include additional channels. Although only certain components of transceiver 112 and receiver 120 are shown in the figures, one in the art understands these modules can contain additional integrated circuits that assist in the operation of optical interconnect 100, such as serializer/deserializer circuits, driver circuits, error processing circuits, and signal processing circuits. Numerous embodiments are encompassed by the following claims.

1. A free-space parallel optical interconnect, comprising:
a first module, comprising:
a first die comprising an array of light sources, each light source emitting light; and
a first common lens for directing the light from each light source to a second module;
the second module.

2. The interconnect of claim 1, wherein the array of light sources is selected from the group consisting of an array of vertical cavity surface-emitting lasers (VCSELs), an array of edge-emitting lasers, and an array of light emitting diodes (LEDs).

3. The interconnect of claim 1, wherein the light sources are spaced apart by 50 microns.

4. The interconnect of claim 1, wherein:
the first die further comprises an array of detectors; and
the first common lens further directs light from the second module to the detectors.

5. The interconnect of claim 1, wherein the first module further comprises:
a second die comprising an array of detectors; and
the first common lens further directs light from the second module to the detectors.

6. The interconnect of claim 1, wherein the first module further comprises:
a second die comprising an array of detectors; and
a second common lens for directing light from the second module to the detectors.

7. The interconnect of claim 1, wherein the second module comprises:
a second die comprising an array of detectors; and
a second common lens for directing the light from each light source to a corresponding detector.

8. The interconnect of claim 7, wherein the array of detectors comprises an array of positive-intrinsic-negative (PIN) photodiodes.

9. The interconnect of claim 7, wherein the detectors are spaced apart by 50 microns.

10. The interconnect of claim 7, wherein:
the second die further comprises a second array of light sources, each light source emitting light; and
the second common lens further directs the light from the second module to the first module.

11. The interconnect of claim 7, wherein the second module further comprises:
a third die comprising another array of light sources, each light source emitting light; and
the second common lens further directs the light from the second module to the first module.

12. The interconnect of claim 7, wherein the second module further comprises:
a third die comprising another array of light sources, each light source emitting light; and
a third common lens for directing the light from the second module to the first module.

13. A method for transmitting data in parallel, comprising:
emitting light from each light source in an array of light sources in a first module, wherein the light from each light source carries data; and
directing the light from each light source with a first common lens to a second module.

14. The method of claim 13, further comprising:
directing light from the second module with a second common lens to detectors in the first module.

15. The method of claim 13, further comprising:
directing light from the second module with the first common lens to detectors in the first module.

16. The method of claim 13, further comprising:
directing the light from each light source with a second common lens to a corresponding detector in an array of detectors in the second module.

17. The method of claim 13, further comprising:
emitting light from each light source in a second array of light sources in the second module; and
directing the light from the second module with a second common lens to the first module.

18. The method of claim 11, further comprising:
emitting light from each light source in a second array of light sources in the second module; and
directing the light from the second module with the first common lens to the first module.
